(19) United States
(12) Patent Application Publication
(10) Pub. No.: US 2014/0063026 A1
(43) Pub. Date: Mar. 6, 2014

(54) SOC PERFORMING DYNAMIC VOLTAGE AND FREQUENCY SCALING POLICIES USING 3D WORKLOAD, AND METHOD USING THE SAME

(71) Applicant: SAMSUNG ELECTRONICS CO., LTD., Suwon-si (KR)

(72) Inventor: IM BUM OH, Hwaseong-si (KR)

(73) Assignee: SAMSUNG ELECTRONICS CO., LTD., Suwon-si (KR)

(21) Appl. No.: 14/016,453

(22) Filed: Sep. 3, 2013

(30) Foreign Application Priority Data
Sep. 4, 2012 (KR) 10-2012-0097465

(51) Int. Cl. G06T 1/20

(52) U.S. Cl. CPC G06T 1/20
USPC 345/519

(57) ABSTRACT

A semiconductor device includes a graphics processor unit (GPU) configured to receive three-dimensional (3D) input data and a central processing unit (CPU) configured to receive the 3D input data and adjust a frequency and operating voltage of the GPU based on the 3D input data. The GPU performs image processing on the 3D input data based on the adjusted frequency and the operating voltage.

### CROSS-REFERENCE TO RELATED APPLICATIONS

This application claims priority to Korean Patent Application No. 10-2012-0097465, filed on Sep. 4, 2012, in the Korean Intellectual Property Office, the disclosure of which is incorporated by reference in its entirety herein.

### BACKGROUND

1. Technical Field

Exemplary embodiments of the inventive concept relate to a semiconductor device (e.g., a system-on chip (SoC)) and a method of operating the same, and more particularly, to a semiconductor device (e.g., a SoC) capable of dynamically adjusting an operating frequency and voltage and a method of operating the same.

2. Discussion of Related Art

A portable device that receives its power from a battery may include an SoC.

The SoC may support complex functions, such as a processor function, a multimedia function, a graphic function, an interface function, and a security function. However, since the SoC of the portable device is supporting such complex functions, it may use up the power of the battery quickly. A portable device may include a graphics processor unit. However, unnecessary power consumption occurs when a graphics processor unit (GPU) continuously operates.

### SUMMARY

According to an exemplary embodiment of the inventive concept, a semiconductor device (e.g., a Soc) includes: a graphics processor unit (GPU) configured to receive 3D input data and a central processing unit (CPU) configured to receive the 3D input data and adjust a frequency and operating voltage of the GPU based on the 3D input data. The GPU performs image processing on the 3D input data based on the adjusted frequency and the operating voltage.

According to an exemplary embodiment of the inventive concept, a semiconductor device (e.g., a Soc) includes: a GPU configured to receive a first 3D input data and generate a first output, a display controller configured to generate a second output based on the first output, the second output including a frame update rate of the second output, and a CPU configured to receive a second 3D input data and the second output and adjust a frequency and operating voltage of the GPU based on the second 3D input and the second output. The GPU performs image processing on the second 3D input data based on the adjusted frequency and operating voltage.

According to an exemplary embodiment of the inventive concept, a semiconductor device (e.g., a Soc) includes: a GPU configured to receive 3D input data and generate processed image data based on the input data, a display controller configured to generate a frame update rate based on the processed image data, and a central processing unit configured to receive the frame update rate and the input data and adjust a frequency and operating voltage of the GPU based on at least one of the input data and the frame update rate.

According to an exemplary embodiment of the inventive concept, a method of operating a semiconductor device (e.g., a system-on chip (SoC)) including a graphics processor unit (GPU) and a display controller includes: receiving at least one of input data input to the GPU and output data output from the display controller; and adjusting an operating frequency and voltage of the GPU based on the received information.

The operating frequency and voltage of the GPU may be adjusted based on a number of vertices or textures and degree of resolutions of the textures of each frame of the input data input to the GPU.

The operating frequency and voltage of the GPU may be adjusted based on a frame update rate of the output data output from the display controller.

The operating frequency and voltage of the GPU may be adjusted based on the number of vertices or textures and degree of resolutions of the textures and the frame update rate.

The operating frequency and voltage of the GPU may be determined based on a value calculated by applying a weight to each of the number of vertices and the frame update rate.

The operating frequency and voltage of the GPU may be changed when at least one of the number of vertices and the frame update rate does not fall within a preset threshold range.

The operating frequency and voltage of the GPU may be changed when both the number of vertices and the frame update rate do not fall within preset threshold ranges, respectively.

The adjusting of the operating frequency and voltage of the GPU may be repeatedly performed at a preset rate.

The operating frequency and voltage of the GPU may be adjusted based on the number of vertices, the frame update rate, and a ratio of a time period that the GPU operates to a time period that whether the GPU operates is measured. For example, the operating frequency and voltage of the GPU may be adjusted based on the number of vertices, the frame update rate, and a ratio of a first time period to a second time period, where the GPU operates during the first time period within part of the second time period, and a measurement of whether the GPU operates occurs during the second time period.

According to an exemplary embodiment of the inventive concept, a system-on chip (SoC) includes a graphics processor unit (GPU) configured to receive input data, generate first output data based on the input data, and output the first output data; a display controller configured to generate second output data based on the first output data, and output the second output data; and a central processing unit (CPU) configured to adjust an operating frequency and voltage of the GPU based on at least one of the input data and the second output data.

The operating frequency and voltage of the GPU may be adjusted based on a number of vertices or textures and degree of resolutions of the textures of each frame of the input data.

The operating frequency and voltage of the GPU may be adjusted based on a frame update rate of the second output data.

The operating frequency and voltage of the GPU may be adjusted based on the number of vertices and the frame update rate of the second output data.

The operating frequency and voltage of the GPU may be adjusted based on the number of vertices, the frame update rate, and a ratio of a time period that the GPU operates to a time period that the GPU performs three dimensional processing.

The operating frequency and voltage of the GPU may be adjusted based on a value calculated by applying a weight to each of the number of vertices, the frame update rate, and the ratio of the time period that the GPU operates to the time period that the GPU performs the three dimensional processing.

According to an exemplary embodiment of the inventive concept, a system-on-chip (SoC) includes a graphics processor unit (GPU) configured to receive data and a central processing unit configured to predict a workload on the GPU by analyzing the data input to the GPU. The CPU sets an operating frequency of the GPU to a first frequency and an operating voltage of the GPU to a first voltage when the predicted workload exceeds a threshold value and sets the operating frequency to a second frequency and the operating voltage to a second voltage otherwise. The first frequency is higher than the second frequency and the first voltage is higher than the second voltage.

In an exemplary embodiment, the GPU operates during a first period, where the GPU performs three dimensional processing only during part of the first period, and a ratio of the part to the first period corresponds to the workload. The data input to the GPU may include a plurality of frames, where the workload is based on a number of vertices within each frame. The SoC may further include a clock management unit CMU connected between the CPU and the GPU, where the CPU controls the CMU to output a clock signal to the GPU with the first frequency when the predicted workload exceeds the threshold and output the clock signal to the GPU with the second frequency otherwise. The SoC may further include a power management integrated circuit PMIC connected between the CPU and the GPU, where the CPU controls the PMIC to output a supply signal to the GPU with the first voltage when the predicted workload exceeds the threshold and output the supply signal to the GPU with the second voltage otherwise.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of an electronic system according to an exemplary embodiment of the inventive concept;

FIG. 2 is a block diagram illustrating the relationship between a dynamic voltage frequency scaling (DVFS) control unit and other devices according to an exemplary embodiment of the inventive concept;

FIG. 3 is a block diagram illustrating signal processing performed based on three-dimensional (3D) DVFS according to an exemplary embodiment of the inventive concept;

FIG. 4 is a timing diagram illustrating a method of measuring a workload on a graphics processor unit (GPU) according to an exemplary embodiment of the inventive concept;

FIG. 5 is a flowchart schematically illustrating a method of operating a semiconductor device (e.g., a system-on chip (SoC)) according to an exemplary embodiment of the inventive concept;

FIG. 6A is a flowchart illustrating a method of operating a semiconductor device (e.g., a SoC) according to an exemplary embodiment of the inventive concept;

FIG. 6B is a flowchart illustrating a method of operating a semiconductor device (e.g., a SoC) according to an exemplary embodiment of the inventive concept;

FIG. 6C is a flowchart illustrating a method of operating a semiconductor device (e.g., a SoC) according to an exemplary embodiment of the inventive concept; and

FIG. 7 is a block diagram of an electronic system including a semiconductor device (e.g., a SoC) according to an exemplary embodiment of the inventive concept.

### DETAILED DESCRIPTION

The inventive concept will now be described more fully hereinafter with reference to the accompanying drawings, in which embodiments of the invention are shown. This invention may, however, be embodied in many different forms and should not be construed as limited to the embodiments set forth herein. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. As used herein, the singular forms “a”, “an” and “the” are intended to include the plural forms as well, unless the context clearly indicates otherwise.

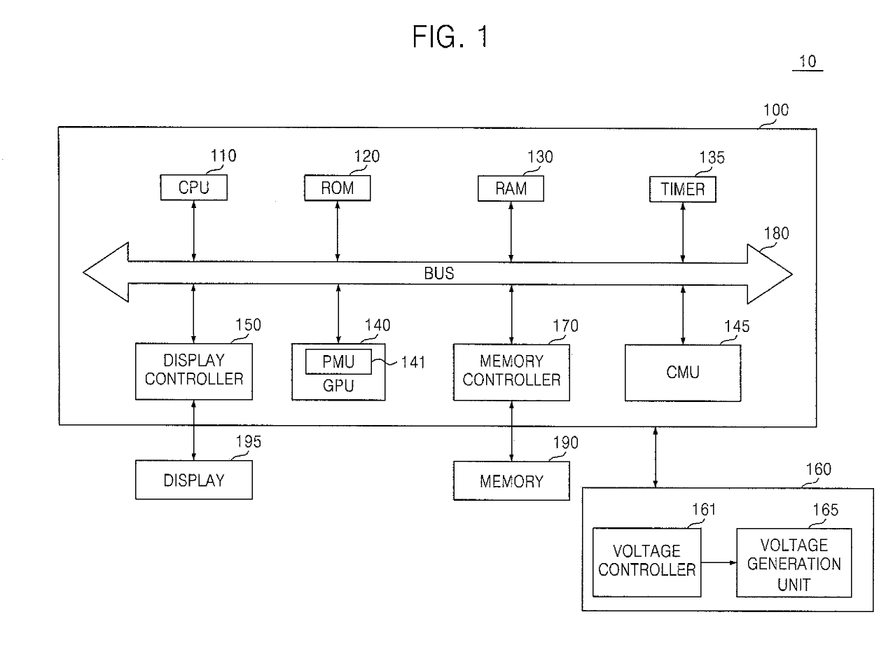

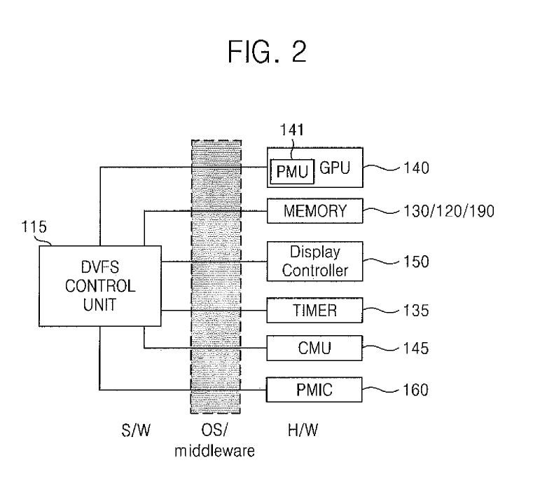

FIG. 1 is a block diagram of an electronic system 10 according to an exemplary embodiment of the inventive concept. FIG. 2 is a block diagram illustrating the relationship between a dynamic voltage frequency scaling (DVFS) control unit 115 and other devices according to an exemplary embodiment of the inventive concept. Referring to FIG. 1, the electronic system 10 may be embodied as a handheld device, such as a mobile phone, a smart phone, a tablet computer, a personal digital assistant (PDA), an enterprise digital assistant (EDA), a digital still camera, a digital video camera, a portable multimedia player (PMP), a personal/portable navigation device (PND), a handheld game console, or an e-book reader.

The electronic system 10 includes a semiconductor device 100, a memory device 190, and a display device 195. The semiconductor device 100 may include a central processing unit (CPU) 110, a read only memory (ROM) 120, a random access memory (RAM) 130, a timer 135, a graphics processor unit (GPU) 140, a clock management unit (CMU) 145, a display controller 150, a memory controller 170, and a bus 180. Although not shown, the semiconductor device 100 may further include other devices or buses. The electronic system 10 may further include a power management integrated circuit (PMIC) 160.

While the PMIC 160 is illustrated in FIG. 1 as being located outside the semiconductor device 100, in an exemplary embodiment of the inventive concept, the PMIC 160 is located within the semiconductor device 100. The PMIC 160 may include a voltage controller 161 (e.g., a voltage control unit) and a voltage generation unit 165.

The CPU 110 (also referred to as a processor) may process or execute programs and/or data stored in the memory device 190. For example, the CPU 110 may process or execute the programs and/or the data according to a clock signal received from a clock signal generator (not shown).

The CPU 110 may be embodied as a multi-core processor. The multi-core processor is one computing component including at least two independent and actual processors (referred to as cores). Each of the at least two processors is capable of reading and performing program instructions. Since the multi-core processor is capable of simultaneously driving a plurality of accelerators, a data processing system including the multi-core processor may perform multi-acceleration.

Programs and/or data stored in the ROM 120, the RAM 130, and the memory device 190 may be loaded to a memory of the CPU 110 if needed.

The ROM 120 may store programs and/or data. The ROM 120 may be embodied as an erasable programmable read-only memory (EPROM) or an electrically erasable programmable read-only memory (EEPROM).

The RAM 130 may temporarily store programs, data, or instructions. For example, programs and/or data stored in the memory 120 or 190 may be temporarily stored in the RAM 130, under control of the CPU 110 or according to a booting code stored in the ROM 120. The RAM 130 may be embodied as a dynamic RAM (DRAM) or a static RAM (SRAM).

The GPU 140 processes data, which is read from the memory device 190 by the memory controller 170, to generate a signal to be displayed.

A power management unit PMU 141 may be located within or at a front end of the GPU 140. In an exemplary embodiment, the GPU 140 is a graphical accelerator. In an exemplary embodiment, the PMU 141 is located outside the GPU 140. The PMU 141 may be configured to measure the performance of the GPU 140. For example, the PMU 141 may measure the amount of data input to the GPU 140 over a given period of time and/or the amount of data output from the GPU 140 over a given period of time, and measure a memory usage of the GPU 140.

The CMU 145 generates an operating clock signal. The CMU 145 may include a clock generation device (e.g., at least one of a phase locked loop (PLL), a delayed locked loop (DLL), and a crystal oscillator).

The operating clock signal may be supplied to the GPU 140. The operating clock signal may also be supplied to another device, e.g., the memory controller 170, etc.

In an exemplary embodiment, the CMU 145 changes a frequency of the operating clock signal under control of the DVFS control unit 115 of FIG. 2. For example, the DVFS control unit 115 predicts a workload to be put on the GPU 140, and selects one of a plurality of preset policies (at least two policies) based on the result of predicting the workload. Each of the plurality of the preset policies, e.g., a first DVFS policy or a second DVFS policy, may have a preset operating frequency and voltage.

In an exemplary embodiment, the DVFS control unit 115 controls the CMU 145 according to the selected policy. Thus, the CMU 145 changes the frequency of the operating clock signal to perform the selected policy (e.g., the first or second policy), under control of the DVFS control unit 115.

In an exemplary embodiment, the voltage control unit 161 controls the voltage generation unit 165 based on the first or second policy selected by the DVFS control unit 115. The voltage generation unit 165 may generate an operating voltage of the GPU 140 and output the operating voltage to the GPU 140 based on the selected first or second policy, under control of the voltage control unit 161. For example, the voltage generation unit 165 generates an operating voltage of the GPU 140 based on the voltage indicated by the selected policy.

The memory controller 170 is configured to interface with the memory device 190. The memory controller 170 controls overall operations of the memory device 190, and controls the exchange of various data between a host and the memory device 190. For example, the memory controller 170 may control the memory controller 170 to write data to or read data from the memory device 190, in response to a request from the host

Here, the host may be a master device, such as at least one of the CPU 110, the GPU 140, and the display controller 150.

The memory device 190 is a device for storing data, and may store an operating system (OS), various programs, and various data. The memory device 190 may be a DRAM but is not limited thereto.

For example, the memory device 190 may be a nonvolatile memory device, e.g., a flash memory, a phase-change RAM (PRAM), a magneto-resistive RAM (MRAM), a resistive RAM (ReRAM), or a ferroelectric RAM (FeRAM). According to an exemplary embodiment of the inventive concept, the memory device 190 is a built-in memory located within the semiconductor device 100.

These devices 110 to 150 and 170 may communicate with one another via the bus 180.

The display device 195 may display an output image signal received from the display controller 150. For example, the display device 195 may be embodied as a liquid crystal display (LCD), a light-emitting diode (LED) display, an organic LED (OLED) display, or an active-matrix OLED (AMOLED) display.

The display controller 150 controls operations of the display device 195.

The DVFS control unit 115 may be embodied as software (S/W) or firmware. The DVFS control unit 115 may be embodied as a program, installed into the memory 120, 130, or 190, and executed by the CPU 110 when the semiconductor device 100 is powered on.

The DVFS control unit 115 may control the memories 120, 130, 190, the timer 135, the GPU 140, the CMU 145, the PMIC 160, and other modules. The memories 120, 130, 190, the timer 135, the GPU 140, the CMU 145, and the PMIC 160 may be each embodied as hardware (H/W).

An operating system (OS) and middleware may be interposed between the DVFS control unit 115 and the memories 120, 130, 190, the timer 135, the GPU 140, the CMU 145, and the PMIC 160.

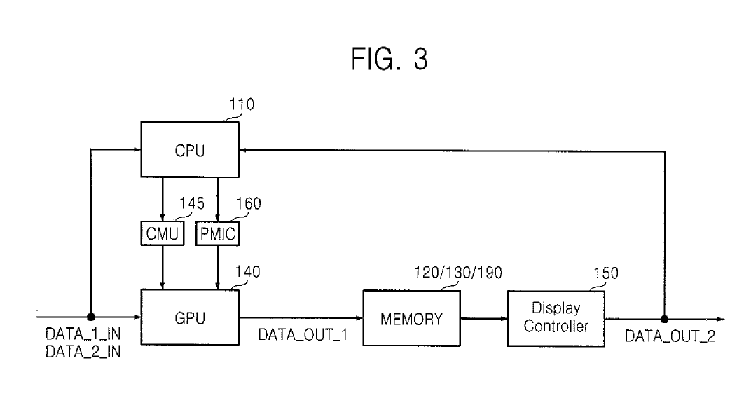

FIG. 3 is a block diagram illustrating signal processing performed based on a three-dimensional (3D) DVFS according to an exemplary embodiment of the inventive concept. Referring to FIGS. 1 to 3, the GPU 140 may receive a first input data DATA_1_IN (e.g., 3D data) and a second input data DATA_2_IN (e.g., 3D data) from the ROM 120, the RAM 130, or the memory device 190. The first input data DATA_1_IN and the second input data contains information for displaying a 3D image. For example, the information for displaying a 3D image may include vertex and texture data. The GPU 140 generates first output data DATA_OUT_1 by processing the first input data DATA_1_IN to be displayed, and outputs the first output data DATA_OUT_1 to a frame buffer. The frame buffer may be included in the ROM 120, the RAM 130, or the memory device 190.

The display controller 150 receives the first output data DATA_OUT_1 from the frame buffer of the memory device 190. Then, the display controller 150 generates second output data DATA OUT_2 based on the first output data DATA_OUT_1, and outputs the second output data DATA OUT to the display device 195.

In exemplary embodiment of the inventive concept, the CPU 110 receives the first input data DATA_1_IN, calculates a workload on the GPU 140 from the PMU 141 and adjusts the operating frequency and voltage of the GPU 140 based on the workload to perform image processing on the first input data DATA_1_IN.

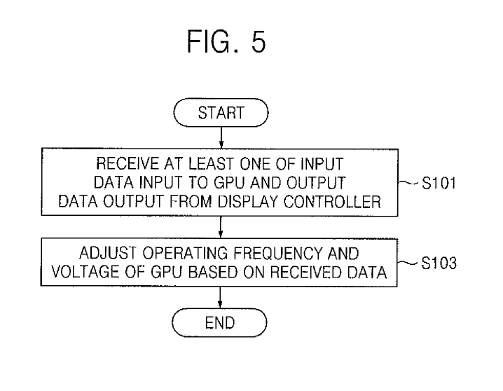

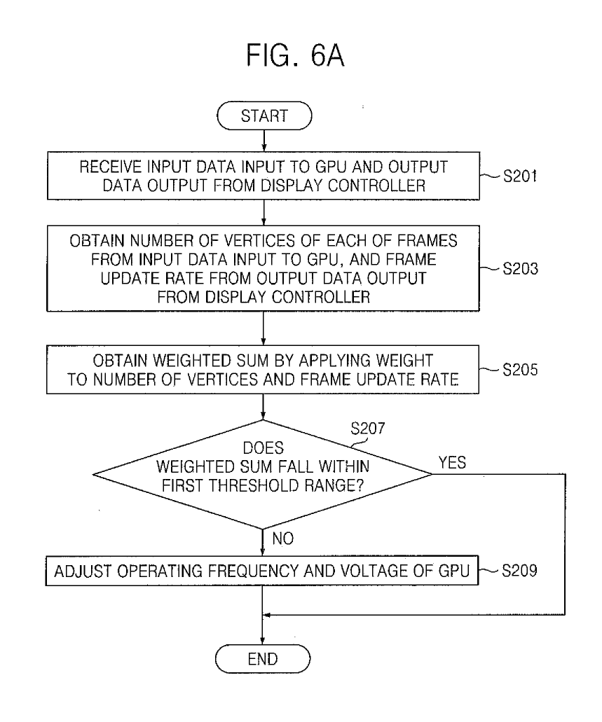

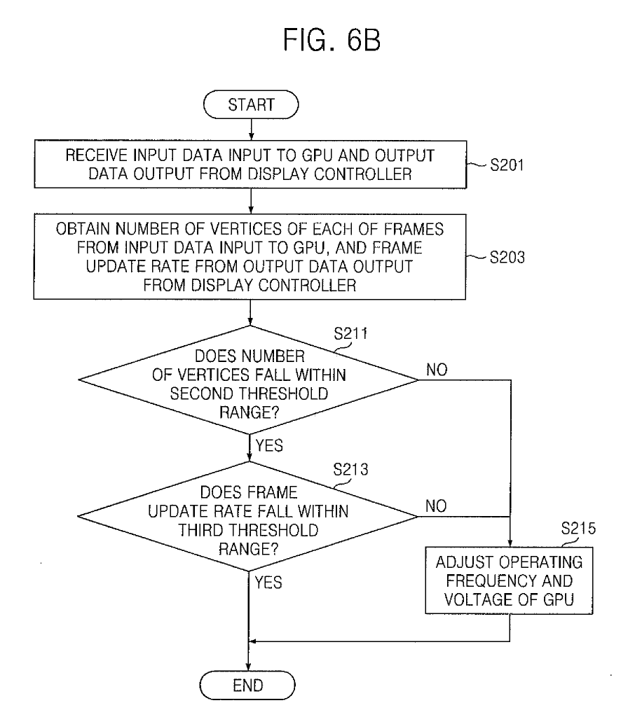

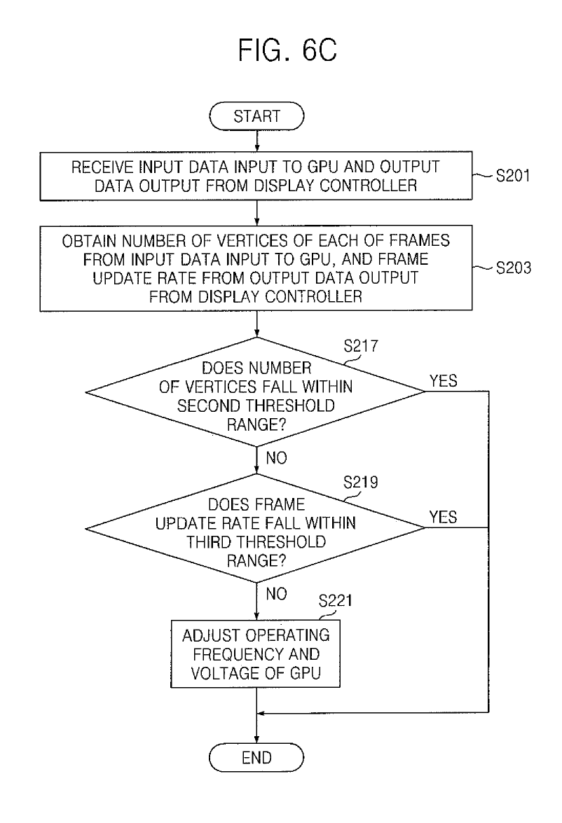

In exemplary embodiment of the inventive concept, the CPU 110 receives the second input data DATA_2_IN and the second output data DATA_OUT_2, calculates a workload on the GPU 140 from the PMU 141 and adjusts the operating frequency and voltage of the GPU 140 based on the received data to perform image processing on the second input data DATA_2_IN. In an exemplary embodiment, the CPU 110 controls the CMU 145 to adjust the operating frequency of the GPU 140 via the DVFS control unit 115, and controls the PMIC 160 to adjust the operating voltage of the GPU 140. This operation will be described in more detail with reference to FIGS. 5 to 6C below, for convenience of explanation.

In an exemplary embodiment, at time 1, first input data DATA_1_IN is output to CPU 110 and GPU 140, at time 2, the GPU 140 processes the first input data DATA_1_IN to generate processed image data DATA_OUT_1 for output to memory 120/130/190, at time 3, the memory outputs the processed image data DATA_OUT_1 to controller 150, at time 4, the controller 150 provides a frame update rate to CPU 110 based on the processed image data DATA_OUT_1, at time 5, the CPU 110 changes the operating frequency and/or the operating voltage of GPU 140 based on the first input data DATA_1_IN and/or the frame update rate, and at time 6, the GPU 140 performs image processing on the second input data DATA_2_IN.

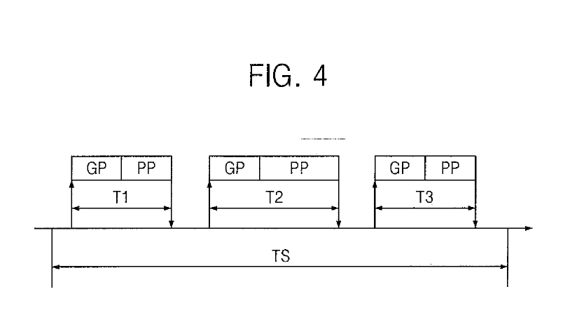

FIG. 4 is a timing diagram illustrating a method of measuring a workload on a GPU according to an exemplary embodiment of the inventive concept. A 3D workload may be expressed as a ratio of an operating time of the GPU, i.e., (T1+T2+T3), to a predetermined measuring time TS. For example, during the measured time TS, the GPU may perform 3D image processing during one set of periods (e.g., T1, T2, and T3) and processing other than 3D processing (e.g., initializing, 2D processing, other tasks, etc.) during a second other set of periods (e.g., between the start of TS to before T1, between T1 and T2, between T2 and T3, and from after T3 to the end of TS). The GPU may also be idle during one or more the second periods or during part of one or more of the second periods. The operating time of the GPU on 3D works is equal to the sum of operating times T1, T2, and T3 for respective 3D works. In an exemplary embodiment of the inventive concept, each of the operating times T1, T2, and T3 for the respective 3D works includes a time needed to perform a geometry process (GP) and a pixel process (PP) in a 3D graphics pipeline, and may be measured using the difference between a point of time when the GPU starts the 3D work and a point of time when the GPU completes the 3D work. The point of time when the GPU starts the 3D work may be defined as a point of time when a 3D driver assigns the 3D work to the GPU and the GPU is thus driven. The point of time when the GPU completes the 3D work may be defined as a point of time when the GPU outputs an event to the 3D driver via an interrupt. For example, a work load WL_GPU on the GPU may be calculated by Equation 1:

$${WL}_{GPU} = \frac{T 1 + T 2 + T 3}{TS} \qquad [ Equation 1 ]$$

FIG. 5 is a flowchart illustrating a method of operating a semiconductor device (e.g., a SOC) according to an exemplary embodiment of the inventive concept. Referring to FIGS. 3 and 5, the CPU 110 receives at least one of the first input data DATA_1_IN and the second input data DATA_2_IN input to the GPU 140 and the output data DATA_OUT_2 output from the display controller 150 based on the second input data DATA_2_IN (operation S101). Then, the CPU 110 adjusts the operating frequency and voltage of the GPU 140 based on the received data to perform image processing on either one of the first input data DATA IN and second input data DATA_2_IN (operation S103).

In an exemplary embodiment, the CPU 110 predicts a degree of a workload of the GPU 140 according to a complexity of the first input data DATA_1_IN before the GPU 140 starts work on the first input data DATA_1_IN, and adjusts the operating frequency and voltage of the GPU 140 by changing a DVFS policy based on the predicted workload. Accordingly, power consumption may be greatly reduced.

For example, the first input data DATA_1_IN input to the GPU 140 may include vertex and texture data. When the number of vertices or textures of each of frames of the first input data DATA_1_IN is large or the first input DATA_1_IN has high resolution textures, it is predicted that a workload to be put on the GPU 140 is high and the operating frequency and voltage of the GPU 140 may thus be increased.

For example, when 3D rendering is performed using an open graphics library for embedded systems application programming interface (OpenGL ES API), a 3D object is drawn using a glDrawArray function and a glDrawElement function. In this case, the number of the vertices of the 3D object is delivered as parameters to these functions. Thus, the number of vertices that are to be drawn for each of the frames may be calculated by counting and accumulating the number of vertices delivered to these functions, storing the accumulated number of vertices in a last stage of each frame, and then initializing the accumulated number of vertices. In an exemplary embodiment, the number of vertices of each of the frames is compared with a reference value, and the operating frequency and voltage of the GPU 140 is increased when the number of vertices is greater than the reference value. The reference value may vary based on the application or type of GPU. In an exemplary embodiment, an average number of vertices is calculated for a certain number of consecutive frames, and the operating frequency and voltage of the GPU 140 is increased when the average number of vertices is greater than the reference value.

A method of adjusting the operating frequency and voltage of the GPU 140 based on the number of vertices of each of frames has been described above, but another factor representing the complexity of the first input data DATA_1_IN or the second input data DATA_2_IN may be used instead of the number of vertices of each of the frames. For example, the other factors may be statistics data such as the numbers of pixels rendered, texels and lights.

The CPU 110 may additionally adjust the predicted and controlled operating frequency and voltage, based on a frame update rate of the output data DATA_OUT_2, which may improve the performance of the display device 195.

For example, the display controller 150 transmits frames to the display device 195 at a predetermined frame rate during representation of an animation. In this case, an actual frame update rate may be measured by counting the number of modified frames or the number of previous frames (i.e., unmodified frames) included among the frames transmitted. In an exemplary embodiment, the frame update rate is compared with a predetermined threshold, and the operating frequency and voltage is increased when the frame update rate is less than the threshold and is reduced or maintained when the frame update rate is greater than the threshold.

A method of adjusting the operating frequency and voltage of the GPU 140 according to a frame update rate has been described above, but another factor may be used instead of the frame update rate. For example, the other factors may be statistics data such as the numbers of pixels rendered, texels and lights. The adjusting of the operating frequency and voltage of the GPU 140 may be repeatedly performed at predetermined rates.

FIG. 6A is a flowchart illustrating a method of operating a semiconductor device according to an exemplary embodiment of the inventive concept. Referring to FIGS. 3 and 6A, the CPU 110 receives the second input data DATA_2_IN input to the GPU 140 and the output data DATA_OUT_2 output from the display controller 150 based on the first input data DATA_1_IN and the first output data DATA_OUT_1 (operation S201). Then, the CPU 110 obtains the number of vertices of each of the frames from the second input data DATA_2_IN, and obtains a frame update rate from the output data DATA_OUT_2 (operation S203). Then, a weight is applied to the number of vertices of each frame and the frame update rate and the weighted values are added to obtain a weighted sum (operation S205). The weight may be a preset value. Then, the weighted sum and a preset first threshold range are compared to determine whether the weighted sum falls within the first threshold range (operation S207). When the weighted sum falls within the first threshold range, the operating frequency and voltage of the GPU 140 are maintained. When the weighted sum does not fall within the first threshold range, the operating frequency and voltage of the GPU 140 are adjusted (operation S209). For example, the operating frequency and voltage of the GPU 140 may be increased when the weighted sum is greater than a maximum threshold, and may be reduced when the weighted sum is less than the maximum threshold.

FIG. 6B is a flowchart illustrating a method of operating a semiconductor device (e.g., a SoC) according to an exemplary embodiment of the inventive concept.

Operations S201 and S203 are as described above with reference to FIG. 6A. After operation S203 is performed, subsequent operations are performed. Specifically, it is determined whether the number of vertices of each of the frames from the second input data DATA_2_IN falls within a second threshold range (operation S211). When the number of vertices of each of the frames falls within the second threshold range, it is determined whether a frame update rate from the output data DATA_OUT_2 falls within a third threshold range (operation S213). When the frame update rate falls within the third threshold range, the operating frequency and voltage of the GPU 140 are maintained. When the number of vertices of each of the frames does not fall within the second threshold range or the frame update rate does not fall within the third threshold range, the operating frequency and voltage of the GPU 140 are adjusted (operation S215).

FIG. 6C is a flowchart illustrating a method of operating a semiconductor device (e.g., a SoC) according to an exemplary embodiment of the inventive concept.

Operations S201 and S203 are as described above with reference to FIG. 6A. After operation S203 is performed, subsequent operations are performed. Specifically, it is determined whether the number of vertices of each of the frames from the second input data DATA_2_IN falls within a second threshold range (operation S217). When the number of vertices of each of the frames does not fall within the second threshold range, it is determined whether a frame update rate from the output data DATA OUT_2 falls within a third threshold range (operation S219). When the frame update rate does not fall within the third threshold range, the operating frequency and voltage of the GPU 140 are adjusted (operation S221). When the number of vertices of each of the frames falls within the second threshold range or the frame update rate falls within the third threshold range, the operating frequency and voltage of the GPU 140 are maintained.

A method of adjusting the operating frequency and voltage of the GPU 140 based on the second input data DATA_2_IN input to the GPU 140 and the output data DATA_OUT_2 output from the display controller 150 has been described above. Alternatively, the operating frequency and voltage of the GPU 140 may be adjusted based on the second input data DATA_2_IN, the output data DATA_OUT_2, and a workload WL_GPU on the GPU 140. The workload WL_GPU may be calculated according to Equation 1. Although the operating frequency and voltage of the GPU 140 may be adjusted using a value calculated by applying a weight to each of the second input data DATA_2_IN, the output data DATA_OUT_2, and the workload WL_GPU, the inventive concept is not limited thereto and the operating frequency and voltage of the GPU 140 may be adjusted according to various other embodiments.

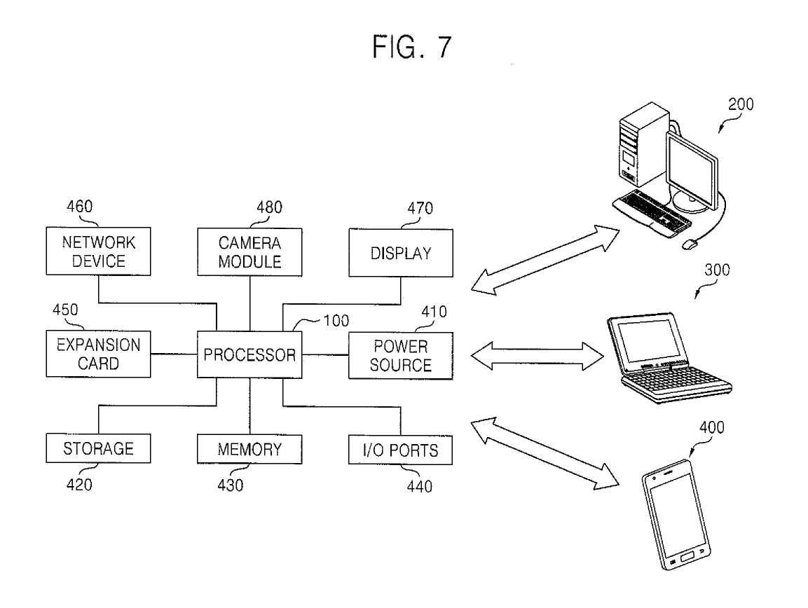

FIG. 7 is a block diagram of an electronic system including a semiconductor device (e.g., a SoC) according to at least one embodiment of the inventive concept. Referring to FIG. 7, the electronic system may be implemented as a PC, a data server, a laptop computer, or a portable device. The portable device may be a cellular phone, a smart phone, a tablet personal computer (PC), a personal digital assistant (PDA), an enterprise digital assistant (EDA), a digital still camera, a digital video camera, a portable multimedia player (PMP), portable navigation device (PDN), a handheld game console, or an e(electronic)-book device.

The electronic system 200, 300 or 400 includes the processor 100, a power source 410, a storage device 420, a memory 430, 110 ports 440, an expansion card 450, a network device 460, and a display 470. The electronic system 200, 300 or 400 may further include a camera module 480.

The processor 100 corresponds to the semiconductor device 100 illustrated in FIG. 1. The processor 100 may be a multi-core processor.

The processor 100 may control the operation of at least one of the elements 410 through 480. The power source 410 may supply an operating voltage to at least one of the elements 100, and 420 through 380. The storage device 420 may be implemented by a hard disk drive (HDD) or a solid state drive (SSD).

The memory 430 may be implemented by a volatile or non-volatile memory. The memory 430 may correspond to the memory device 190 illustrated in FIG. 1. A memory controller (not shown) that controls a data access operation, e.g., a read operation, a write operation (or a program operation), or an erase operation, on the memory 430 may be integrated into or embedded in the processor 100. Alternatively, the memory controller may be provided between the processor 100 and the memory 430.

The I/O ports 440 are ports that receive data transmitted to the electronic system 400 or transmit data from the electronic system 400 to an external device. For instance, the I/O ports 440 may include a port for connecting with a pointing device such as a computer mouse, a port for connecting with a printer, and a port for connecting with a universal serial bus USB drive.

The expansion card 450 may be implemented as a secure digital (SD) card or a multimedia card (MMC). The expansion card 450 may be a subscriber identity module (SIM) card or a universal SIM (USIM) card.

The network device 460 enables the electronic system 400 to be connected with a wired or wireless network. The display 470 displays data output from the storage device 420, the memory 430, the I/O ports 440, the expansion card 450, or the network device 460.

The camera module 480 converts optical images into electrical images. Accordingly, the electrical images output from the camera module 480 may be stored in the storage device 420, the memory 430, or the expansion card 450. Also, the electrical images output from the camera module 480 may be displayed through the display 470.

According to an exemplary embodiment of the inventive concept, a workload that is to be put on a graphics processor unit is predicted according to the type of input data to be processed by the graphics processor unit, thereby enabling dynamic adjustment of the operating frequency and voltage of the graphics processor unit. Accordingly, power consumption may be greatly reduced.

Furthermore, the predicted and adjusted operating frequency and voltage of the graphics processor may be additionally adjusted based on the number of frames updated in a display device, which may improve performance of the display device.

While the inventive concept has been particularly shown and described with reference to exemplary embodiments thereof, it will be understood that various changes in form and details may be made therein without departing from the spirit and scope of the invention.

What is claimed is:

1. A semiconductor device comprising:
a graphics processor unit (GPU) configured to receive three-dimensional (3D) input data; and
a central processing unit (CPU) configured to receive the 3D input data and adjust a frequency and operating voltage of the GPU based on the 3D input data,
wherein the GPU performs image processing on the 3D input data based on the adjusted frequency and the operating voltage.

2. The semiconductor device of claim 1, wherein the 3D input data includes a number of vertices of each frame of the 3D input data.

3. The semiconductor device of claim 2, wherein the 3D input data further includes a number of textures of each frame of the 3D input data.

4. The semiconductor device of claim 2, wherein the semiconductor device is a system-on chip (SoC).

5. The semiconductor device of claim 3, wherein the operating frequency and voltage of the GPU are changed when at least one of the number of vertices and textures does not fall within a preset threshold range.

6. The semiconductor device of claim 5, wherein the operating frequency and voltage of the GPU are changed when both the number of vertices and textures do not fall within preset threshold ranges, respectively.

7. A semiconductor device comprising:
a graphics processor unit (GPU) configured to receive a first three-dimensional (3D) input data and generate a first output;
a display controller configured to generate a second output based on the first output, the second output including a frame update rate of the second output; and
a central processing unit (CPU) configured to receive a second 3D input data and the second output and adjust a frequency and operating voltage of the GPU based on the second 3D input and the second output,
wherein the GPU performs image processing on the second 3D input data based on the adjusted frequency and operating voltage.

8. The semiconductor device of claim 7, wherein the first and the second 3D input data includes a number of vertices of each frame of the first and the second 3D input data respectively.

9. The semiconductor device of claim 8, wherein the first and the second 3D input data further includes a number of textures of each frame of the first and the second 3D input data respectively.

10. The semiconductor device of claim 8, wherein the semiconductor device is a system-on chip (SoC).

11. The semiconductor device of claim 10, wherein the operating frequency and voltage of the GPU are changed when at least one of the number of vertices and the frame update rate does not fall within a preset threshold range.

12. The semiconductor device of claim 11, wherein the operating frequency and voltage of the GPU are changed when both the number of vertices and the frame update rate do not fall within preset threshold ranges, respectively.

13. The semiconductor device of claim 9, wherein the operating frequency and voltage of the GPU are changed when both the number of vertices, the number of textures and the frame update rate do not fall within preset threshold ranges, respectively
